(19) United States
(12) Patent Application Publication
(10) Pub. No.: US 2004/0122940 A1
(43) Pub. Date: Jun. 24, 2004

(54) Method for monitoring applications in a network which does not natively support monitoring

(76) Inventors: Edward S. Gibson, Allen, TX (US); Sterling C. Reames, Frisco, TX (US); Dale R. Wright, Frisco, TX (US)

Correspondence Address: KRAMER LEVIN NAFTALIS & FRANKEL LLP, INTELLECTUAL PROPERTY DEPARTMENT, 919 THIRD AVENUE, NEW YORK, NY, 10022, US

(21) Appl. No.: 10/325,719

(22) Filed: Dec. 20, 2002

(51) Int. Cl. G06F 15/173

(52) U.S. Cl. 709/224; 719/318

(57) ABSTRACT

A system and method for providing non-invasive monitoring capability for systems and applications not designed for integrated monitoring. According to an exemplary embodiment, a Watcher application is tasked with accessing data relating to the system or application, analyzing the data to determine the existence of a monitoring event, and notifying a monitoring system of said monitoring event. In exemplary embodiments, a Watcher 110 monitors data in an application or system database, monitors an execution environment of the application or system, or accesses the system or application directly via an application programming interface.

### TECHNICAL FIELD

The present invention relates to software maintenance and management, and more particularly, to a system and method for monitoring system applications that were not originally designed to support granular monitoring.

### BACKGROUND INFORMATION

Ideally, a system application running on one or more data processing devices would be associated with a monitoring application. Such association is very useful when the system application is running in numerous remote physical locations which communicate across a network. Such a device or application, for ease of illustration, will be referred to herein as a device or application with “native monitoring.” Example of common devices or system applications that support “native monitoring” are, for example, any device that implements the SNMP protocol. SNMP refers to the “Simplified Network Management Protocol”, commonly used in network monitoring

The present invention is directed to systems which do not have integrated monitoring support. Such systems are often legacy systems, or data processing applications which reflect an earlier state of technology, which are ubiquitous in many large scale data processing enterprises, systems, networks and entities. Alternatively, such non-native monitoring systems could be newer systems and applications for which, for whatever reasons, no monitoring need was originally foreseen, but such need subsequently has emerged. In fact, most applications do not implement a monitoring ability, such as for example, database programs such as Microsoft Access, other numerous applications on midrange systems that are, for example, UNIX based. Such systems and applications will be referred to herein as “non-native monitoring” systems and applications.

In a network context, there is an inherent problem in running non-native monitoring systems and/or applications, especially when one or more critical tasks are implemented in such non-native monitoring applications. A network administrator—who may be physically far away from the system or application in question—has no means by which to determine whether the application or system is actually properly functioning. Such situations could have dire consequences. For example, an enterprise level application maintains connections to various associated systems, such as, for example, an order entry system which has links to customer databases, provisioning systems, verification systems, credit checking systems, etc. If the system loses connectivity to a key system, then processing will halt until that connection can be reestablished. In the case of such an order entry system, it is common for the first notification that a connection has failed not to be made until the end users of the system discover that they are no longer able to process orders. It is obviously much preferred to be able to promptly know when a connection to any of the associated systems failed, so as to save backlog, lost data, and not have to first hear of system problems from customers.

Conventionally, commercially available monitoring solutions are aimed at computing components such as, for example, servers, desktops, routers, switches, etc.; or to applications and/or services that provide for monitoring by design, such as, for example, large Enterprise Resource Planning (“ERP”) systems, databases and the like. Enabling a custom or non-enabled application for detailed monitoring simply is not supported.

Thus, given legacy or other non-native monitoring systems and applications, and no viable after-market solution or retrofit to provide monitoring, what are enterprise system administrators to do such that they can monitor such non-native monitoring systems and applications? It is not cost effective to add voluminous lines of computer code specific to each such non-native monitoring software system or application to “retrofit” such system with the ability to be integrated to a monitoring application. Such an approach would, for example, create one or more logs of audit, error, and/or access information which is undesirable. In fact, such a solution might be termed an “invasive” method of software system application monitoring, and would be non-optimal and not at all justified.

Accordingly, what is therefore needed in the art is a “non-invasive” method of software system and application monitoring that allows an enterprise to monitor legacy and/or other non-native monitoring systems and applications.

### SUMMARY OF THE INVENTION

A system and method are presented for providing non-invasive monitoring capability for systems and applications not designed for integration with monitoring applications. According to an exemplary embodiment, a Watcher is tasked with accessing data relating to the system or application, analyzing the data to determine the existence of a monitoring event, and notifying a monitoring system of said monitoring event. In exemplary embodiments, a Watcher monitors data in an application or system database, monitors an execution environment of the application or system, and/or accesses the system or application directly via an application programming interface.

### BRIEF DESCRIPTION OF THE DRAWINGS

FIG. 1 depicts an exemplary application with an exemplary non-invasive monitoring application connected thereto according to an embodiment of the present invention; and

FIG. 2 depicts an exemplary modular software program implementing an exemplary embodiment of the present invention.

### DETAILED DESCRIPTION

The present invention is directed to a non-invasive method of software system application monitoring. The present invention provides monitoring information, such as, for example, performance and/or health statistics, for applications or systems that were not designed to support granular monitoring.

In order to provide monitoring information, a mechanism that supports the collection of needed metrics must be enabled. In an exemplary embodiment, a “Watcher” process is tasked with assessing the execution environment and/or data related to a given system or application, and assessing if a condition exists that warrants the issuance of a monitoring message.

The methods of data collection by such Watcher may include, for example, (1) monitoring data in a given application's database, (2) monitoring an execution environment of an application, such as, for example, the CPU usage or other parameters, memory usage or other suitable parameters, network connection status including number and quality of network connections, network congestion, end-to-end or point-to-point traversal time, throughput, identification of connected components, network traffic, and/or transaction volume, etc. or (3) monitoring an application via an Application Programming Interface (API) giving the Watcher access to the application itself. According to an exemplary embodiment of the present invention, such a Watcher would notify an “Emitter” process which can be configured to emit monitoring data points to an associated monitoring system. The method of communication between an Emitter process and an associated monitoring system is, in general, dependent upon the specific monitoring system used. A Watcher could use, for example, SNMP traps, writing to log files, sending XML messages, or sending emails as possible communications avenues, or could use any other computer communications protocol, application, process or method as may be known in the art.

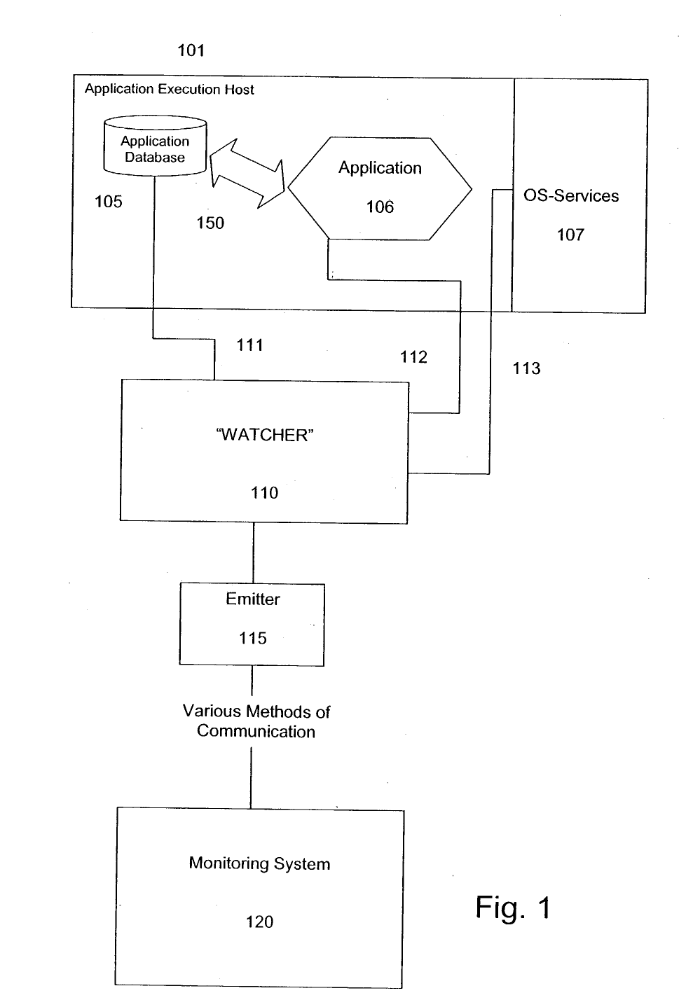

With reference to FIG. 1, an exemplary application is depicted with, according to an embodiment of the method of the present invention, a Watcher 110, an Emitter 115 and a monitoring system 120. With reference to FIG. 1, there is shown an application 106 and an application database 105 which have a high bandwidth communications pathway 150 connecting them. The application 106 and the application database 105 may be co-located, or may be physically distributed and communicating via a high speed, high bandwidth bus, network link, or other communications pathway, as may be known in the art. As well, the application 106 and the application database 105 reside, either virtually or physically, in an application execution host 101 which also runs operating system services 107 to facilitate processes such as application 106 as well as other applications. The above described elements of FIG. 1 appearing within the application execution host 101 represent a non-native monitoring application running on a host and accessing operation system services, and therefore are representative of a legacy system application where no native monitoring is provided.

According to an exemplary embodiment of the present invention, a Watcher 110 is provided which has communications pathways 111, 112 and 113, respectively, leading to the application database, to the application itself, and to the operating system services 107 of the application execution host 101. Such communications pathways can be, for example, via residing on the same server or computer as the application, or across network or other remotes communications pathways as are known in the art. The Watcher 110 uses, for example, inputs and outputs to the application 106 to collect needed metrics. Such metrics are those operational parameters and data as would be commonly collected via a built-in and/or integrated monitoring application in a native monitoring system. The Watcher 110, for example, can run a continuous loop, looking at various inputs to and outputs from the application 106 as well as the application's availment of operating system services 107. The Watcher 110 determines, for example, whether a condition exists that warrants the issuance of a monitoring datapoint. If such condition does exist, the Watcher 110 notifies an Emitter 115, which is configured to emit the monitoring datapoint or datapoints to an associated monitoring system 120. As described above, the Emitter 115 communicates with the monitoring system 120 via various methods of communication as may be known in the art.

Operational parameters that a Watcher 110 looks at could be anything that the application 106 being monitored provides a way to access noninvasively. For example, one aspect that could be monitored would be an activity load operational parameter. In this exemplary case, a Watcher 110 will initialize itself at startup with a current assessment of the transaction load on an application 106. Then, during its continuous monitoring loop it would reassess the apparent load, expressed, for example, as the number of transactions processed since the last check, and decide if the load was in excess of specified operational parameters. If the load was in fact in excess of defined operational parameters, the Watcher 110 would issue a message via the Emitter to the monitoring system 120.

The Watcher 110 could further be configured to use a database ID with sufficient privileges to access any needed information. For example, data could be accessed using database specific access methods which are generally unique to the vendor of the database. However, such access methods and required identifications are, of course, available to those with appropriate access to the application, and using them does not require any retrofitting, modification, or enhancement of the application code, thus preserving the non-invasive character of the method of the present invention.

The Watcher 110 could also need access to log files, as well as any Application Programming Interfaces that may exist to application 106. Thus, the Watcher 110 could need to be granted sufficient privileges to access these resources as well. For example, if a Watcher 110 needed access to log files written by an application, then generally available file access methods, as are known in the art, would be used by the Watcher 110. If the Watcher 110 were to use an application API, then the application API would define any protocols which the Watcher 110 would need to utilize.

With respect to operating system services 107, the Watcher 110 could either use scripts against the operating system or use direct operating system access to access operating system level items needed to verify operational parameters. The access that the Watcher 110 requires to the database 105, application 106, and operating system 107 may or may not be via network access. In the case of operating system services, the Watcher 110 would likely need to be on, or running within, the operating system instance being accessed. While there are ways to access operating system services from remote machines that could be utilized, in exemplary embodiments the Watcher 110 and the application being monitored would be co-located.

It is not necessary that the Watcher 110 be co-located with an Emitter, inasmuch as a Watcher 110 could communicate with an Emitter over either a local area network, or a wide area network such as, for example, the Internet. Of course, a Watcher 110 and an Emitter could be co-located and then the Emitter would communicate with a monitoring application across a network or other communications link. In general, a monitoring application will be centralized and will not be co-located with a particular application, but this could be the case in exemplary embodiments of the present invention as may be desired.

What will next be discussed are the specific details of an exemplary Watcher 110. In general, the Watcher 110 can be implemented in any language that had access to the application aspect that was being monitored. In the case where an application programming interface (“API”) is used, such an API may require the use of a given language, such as, for example, C/C++. Alternatively, in other exemplary embodiments, JAVA will be used due to its ability to execute in most operation system environments and its wide database support.

What a Watcher 110 actually monitors can be dependent upon the monitoring goals. In general, the monitored data will be specific to a given embodiment and implementation. If a primary goal of the non-invasive monitoring is to ensure that an application is available and processing data correctly, then there could be several items monitored. For example, a Watcher 110 could access an API to verify that an application responds in a timely manner. Alternatively, a Watcher 110 could also watch the growth of an application's log files to determine the amount of activity within the application and whether it is within user defined acceptable limits. As well, a Watcher 110 could access operating system services to monitor the health of network connections, as well as that of a machine itself. Or, for example, a Watcher 110 could access an execution environment of an application, and look at, for example, CPU usage or other parameters, memory allocation and usage or other parameters, network connections, congestion and/or volume or other network parameters, etc. If any data originating from these data sources, or any derived metrics or parameters based thereon, were deemed by a Watcher 110 to represent a problem, a monitoring system 120 would be notified.

In general, the processing of the data it accesses, and the rules, thresholds or tests which a Watcher 110 applies to such data, are functions of the system, application, or application component being monitored, and will be specified by a user for any given Watcher 110 in an exemplary embodiment of the present invention.

The functionality in separating a Watcher 110 from an Emitter can be a logical one. Thus; the exemplary structure as depicted in FIG. 1, and as described above, which has a Watcher 110 separate and distinct from an Emitter, is not necessary. However, in exemplary embodiments, a Watcher 110 will be a distinct component from an Emitter for communications purposes.

As is known in the art, certain types of messaging come with guarantees of delivery. For example, in the TCP/IP set of protocols, a User Datagram Protocol (“UDP”) datagram does not have a guaranteed delivery aspect, whereas a TCP segment does. Thus, depending upon network congestion a UDP datagram could be dropped at any point in its path through a given network. This risk increases with the required number of hops through the network to a destination. In exemplary embodiments, a Watcher 110 may communicate with an Emitter 115 over a high confidence local area network or other high confidence communications link, and to save computing overhead, format its messages to the Emitter 115 using UDP datagrams. However, if in such exemplary embodiments the monitoring application is remotely located, as is common in centralized monitoring embodiments, the Emitter 115 will need to reformat the messages it receives from the Watcher 110 using some type of data transmission protocol which can guarantee their arrival at a monitoring application. Such guaranteed delivery communications protocol could be, for example, TCP segments, or other communications protocols which guarantee delivery as may be known in the art.

Since an Emitter 115 could be integrated as a component of the Watcher 110, the exemplary embodiment depicted in FIG. 1 is not intended to limit in any way the possibility of, in alternative exemplary embodiments, combining an Emitter 115 and a Watcher 110. As noted, it is not necessary that they be either combined or co-located, and can have numerous possible remote locations, connected by numerous possible communications pathways, as may be known in the art.

The following is exemplary psuedocode implementing an exemplary embodiment of the present invention.

MAIN

On startup assess the baseline operation of the monitored application component

WHILE (ACTIVE=TRUE)

DO

FOR each monitored application component verify that operational parameters have not been exceeded;

IF an operational parameter is out of bounds notify the monitoring system

END IF

END MAIN

An exemplary implementation of the system and method of the present invention might be as follows. Assume a given exemplary enterprise level application maintains connections to various associated systems. For example, an order entry system may have links to customer databases, provisioning systems, verification systems, credit checking systems, etc. If such exemplary order entry system loses connectivity to one or more key systems, then processing will simply halt until that connection can be re-established. Conventionally, in the case of an order entry system, it is common for the first notification of a connection being down to be made by end users of the system when they discover that they are no longer able to process orders. Using the system and method of an embodiment of the present invention, a exemplary watcher process can be, for example, implemented to monitor all connections to such associated systems. When a connection fails, such exemplary watcher process could then notify a monitoring system of a problem with the application. Thus, such exemplary order system operators would not have to hear about the problem from end users, which could be their customers, and problems due to an extended down time, such as, for example, lost data, lost sales, etc. could be avoided.

Alternatively, a watcher process could, for example, be designed to extract lines from a log file that an example application is writing to. Such watcher could extract each line, or every N-th line, where N is some positive integer. Such exemplary watcher could, for example, analyze the contents of such extracted log files for monitoring events, such as, for example, in a storage system application, the wrong file sizes being logged, or the wrong file extensions being logged, etc., indicating that there is a problem with the storage system process. Upon identifying such exemplary monitoring events, the exemplary watcher could notify the storage system itself, or a separate monitoring application, as described above.

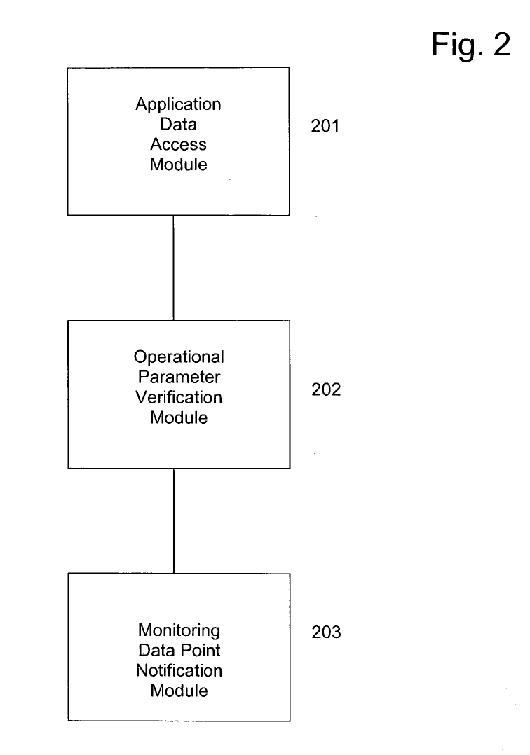

FIG. 2 depicts an exemplary modular software program of instructions which may be executed by an appropriate data processor as is known in the art, to implement an exemplary embodiment of the present invention. The exemplary software program may be stored, for example, on a hard drive, flash memory, memory stick, optical storage medium, or such other data storage device or devices as are known in the art. When the program is accessed by the CPU of an appropriate data processor and run, it performs, according to an exemplary embodiment of the present invention, a method of non-invasive software system application monitoring. The exemplary software program has three modules, corresponding to three functionalities that can be associated with an exemplary embodiment of the present invention.

The first module is, for example, an Application Data Access Module 201, which can access data input to or output from an application, data in an application database, or data related to an execution environment of an application, as described above. As well, the Application Data Access Module 201 can access information regarding an application's use of operating system services running on the application's execution host.

A second module is, for example, an Operational Parameter Verification Module 202, which, using a high level language software implementation of the pseudocode described above, verifies that specified operational parameters have not been exceeded for each monitored application component. The Operational Parameter Verification Module 202 also can determine if a given operational parameter is out of bounds. If it is, a third module, for example, a Monitoring Data Point Notification Module 203, using, for example, one of various methods of communication described above, notifies a monitoring system of the triggering event or monitoring data point.

Modifications and substitutions by one of ordinary skill in the art are considered to be within the scope of the present invention, which is not to be limited except by the following claims.

What is claimed:

1. A method of providing monitoring of an application comprising:
accessing data relating to the application, wherein the application lacks a native monitoring capability;
analyzing the data to determine existence of a predetermined monitoring event; and
notifying a monitoring system of the predetermined monitoring event;
wherein the predetermined monitoring event includes a set of user defined occurrences.

2. The method of claim 1, where said accessing of data relating to the application includes accessing data in a database associated with the application.

3. The method of claim 2 wherein accessing of data in the databases uses information.

4. The method of claim 2, wherein accessing of data in the database are a database specific access method.

5. The method of claim 1, where said accessing of data relating to the application includes monitoring an execution environment of the application.

6. The method of claim 5, where said monitoring of an execution environment of the application includes monitoring network connections and machine parameters.

7. The method of claim 5, where said execution environment of the application includes at least one of a CPU parameter, a memory parameter, a network connection status, and a network volume.

8. The method of claim 1, where said accessing of data relating to the application includes accessing the application via an API.

9. The method of claim 8, where said data includes a response time of the application to an input launched via the API.

10. The method of claim 1, where said accessing data includes watching a growth of a log files of the application to determine the amount of activity within the application and whether the amount is within a predetermined acceptable limit.

11. A monitoring system for non-invasive monitoring, comprising:
a watcher component;
an emitter component coupled to the watcher component; and
a monitoring application coupled to the emitter component,
wherein the watcher component accesses operational parameters relating to an application, wherein the application lacks a native monitoring capability, the watcher component analyzes the operational parameters of the application for monitoring events, and notifies the monitoring application of the monitoring events via the emitter component.

12. The system of claim 11, wherein the watcher component is implemented in one of a software implementation, a hardware implementation, a firmware implementation and a combination software and hardware implementation.

13. The system of claim 11, wherein accessing operational parameters includes accessing the application via an API.

14. The system of claim 12, wherein said operational parameters include a response time of the application to an input launched via the API.

15. The system of claim 11, where said accessing of operational parameters includes watching a growth of a log files of the application to determine the amount of activity within the application and whether the amounts are within a predetermined acceptable limit.

16. A computer program product comprising a computer usable medium having computer readable program code means embodied therein, the computer readable program code means in said computer program product comprising means for causing a computer to:
access data relating to an application wherein the application lacks a natural monitoring capacity;
analyze the data to determine existence of a predetermined monitoring event; and
notify a monitoring system of the predetermined monitoring event.

17. The computer program product of claim 15, where said access data relating to application includes at least one of access data in a database associated with the system or application, using a database ID, monitoring an execution environment of the application, and accessing the application via an API.

18. The computer program product of claim 15, where the predetermined monitoring event includes an operational parameter of the application exceeding a predetermined acceptable limit.

19. A program storage device readable by a machine, tangibly embodying a program of instructions executable by the machine to perform a method of providing monitoring of applications or systems not designed to support monitoring, said method comprising:
accessing data relating to the system or application;
analyzing the data to determine the existence of a monitoring event; and
notifying a monitoring system of said monitoring event.

20. The program storage device of claim 18, where the accessing of data relating to the system or application includes at least one of accessing data in a database associated with the system or application, using a database ID with sufficient privilege to access any needed information, monitoring an execution environment of the system or application, and accessing the system or application itself via an API.

21. The program storage device of claim 19, where said monitoring of an execution environment of the application includes monitoring network connections and machine parameters, and where said execution environment of a system or application includes at least one of a CPU, memory, network connections, or network volume.
